(19) United States
(12) Patent Application Publication
(10) Pub. No.: US 2024/0427876 A1
(43) Pub. Date: Dec. 26, 2024

(54) EXPLOITABILITY PREVENTION GUIDANCE ENGINE

(71) Applicant: International Business Machines Corporation, Armonk, NY (US)

(72) Inventors: Rick Woodward, Ashland, VA (US); Carlos E. Aguilera, Marietta, GA (US); Karl Kakadelis, Simpsonville, SC (US)

(21) Appl. No.: 18/214,088

(22) Filed: Jun. 26, 2023

(51) Int. Cl. G06F 21/55; G06F 21/57

(52) U.S. Cl. CPC G06F 21/552; G06F 21/577

(57) ABSTRACT

Results of a simulated cybersecurity attack performed against a target computer environment can be received. An analogous computer environment can be identified in a context database that performed better against the simulated cybersecurity attack, where the context database stores information associated with a plurality of computer environments and previously performed cybersecurity attack simulations on the plurality of computer environments, and where the analogous computer environment is identified that exhibits acceptable cybersecurity hardening from types of exploits employed in the simulated cybersecurity attack. Configurations associated with the analogous computer environment can be recommended to the target computer environment.

### BACKGROUND

The present application relates generally to computers and computer applications, tools that guide in prevention of cyberattacks, and more particularly to exploitability prevention guidance engine.

Organizations that are attempting to prevent successful cyberattacks often use automated scanning tools to identify known vulnerabilities in their systems. These tools, however, may not provide a comprehensive view into the capabilities of an adversary. While threat-based simulation attacks may be performed by organizations in order to determine possible cyber risks, such simulations also may not provide effective solutions or recommendations to an organization.

### BRIEF SUMMARY

The summary of the disclosure is given to aid understanding of a computer system and method of exploitability prevention guidance engine, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A computer-implemented method, in an aspect, can include receiving results of a simulated cybersecurity attack performed against a target computer environment. The method can also include identifying an analogous computer environment in a context database that performed better against the simulated cybersecurity attack. The context database can store information associated with a plurality of computer environments and previously performed cybersecurity attack simulations on the plurality of computer environments, The method can further include recommending configurations associated with the analogous computer environment to the target computer environment.

A system, in an aspect, can include at least one processor. The system can also include at least one memory device coupled with the at least one processor. At least one processor can be configured to receive results of a simulated cybersecurity attack performed against a target computer environment. At least one processor can further be configured to identify an analogous computer environment in a context database that performed better against the simulated cybersecurity attack, the context database storing information associated with a plurality of computer environments and previously performed cybersecurity attack simulations on the plurality of computer environments. At least one processor can also be configured to recommend configurations associated with the analogous computer environment to the target computer environment.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement exploitability prevention guidance engine in an embodiment.

FIG. 2 is a diagram illustrating inputs into an exploitability prevention guidance engine in an embodiment.

FIG. 3 is a diagram illustrating context database components in an embodiment.

FIG. 4 is a flow diagram illustrating a method of exploitability prevention guidance in an embodiment.

FIG. 5 is a diagram illustrating components of an exploitability prevention guidance engine in an embodiment.

FIG. 6 is a flow diagram illustrating a use case of an exploitability prevention guidance in an embodiment.

FIG. 7 is a diagram showing components of a processing system in one embodiment that can perform exploitability prevention guidance.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as exploitability prevention guidance engine code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

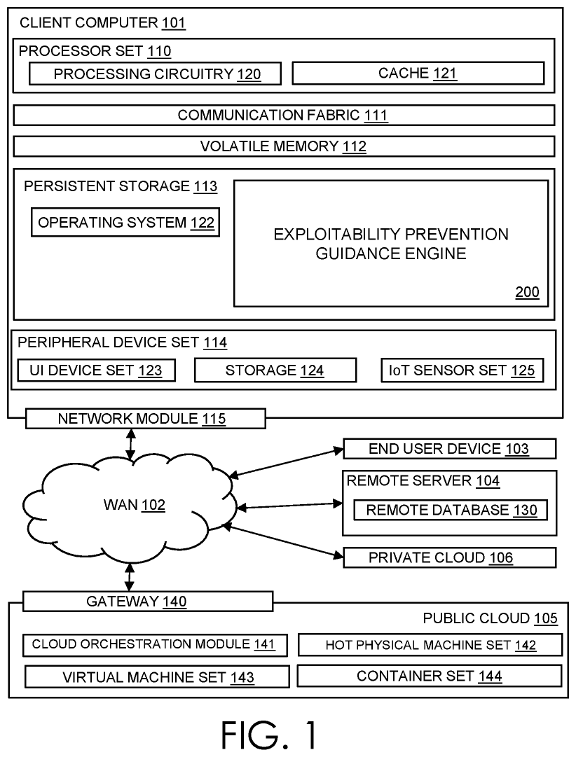

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In one or more embodiments, methods, and/or techniques are disclosed that can provide data-driven recommendations for countering specific exploit techniques by a cyber adversary, based on the performance of other organizations against the similar exploit techniques, e.g., tactics, techniques, and procedures (TTPs) performed by an adversary for cyberattacks. A tool or component that performs such a method or technique in one or more embodiments can also be referred to herein as an exploitability prevention guidance engine (EPGE). In an embodiment, EPGE can be a software engine. A system including at least one processor that incorporates such a method or technique (e.g., EPGE) in one or more embodiments can also be provided.

EPGE can produce recommendations that are specific to an organization's computer configurations such as, but not limited to, security tool configuration, operating system (OS) configuration, network control configuration (e.g., firewall, segmentation), software and/or Software as a Service (SaaS) configuration, network schema (e.g., micro-segmentation, software-based networking, cloud setup), container configurations, software development and testing tooling, and/or awareness and training resources. EPGE can also be designed to provide insights about a computer environment or system's security posture in comparison to other organizations related to items like geolocation, market, size, and technological footprint.

In one or more embodiment, EPGE can use aggregated data produced by organizations performing cybersecurity simulations, which imitate an adverse attack, e.g., acting as an adversary, attempting to identify and exploit potential weaknesses within the organization's cyber defenses using various attack techniques. For instance, automated attacker simulation tools can be used to create a database of effective and ineffective system configurations against particular exploits. EPGE can use this data to make tailored recommendations for organizations that are ineffective at blocking, detecting, logging, or responding to particular exploits based on other organizations that have been successful in blocking, detecting, logging, or responding to that same exploit. In an embodiment, the logic of EPGE takes into consideration the technical environment (such as, but not limited to, operating systems, security tooling, network design, vendors, regulatory environment, industry, installed software, and size) of a participating organization to refine these recommendations to be actionable and effective at preventing exploitability.

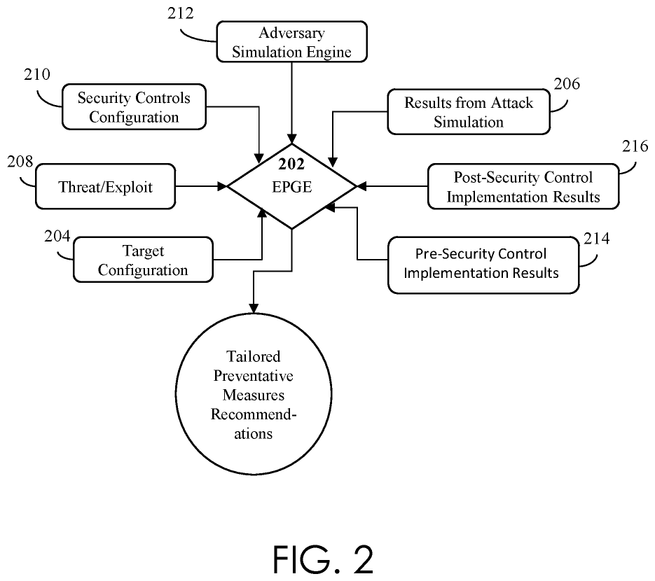

FIG. 2 is a diagram illustrating inputs into an exploitability prevention guidance engine in an embodiment. Inputs for an exploitability prevention guidance engine 202 can include configuration of a target system 204, the target computer system's security controls configuration 210, other information associated with an adversary simulation engine such as a tool used for simulating a cybersecurity attack (which may inform categories of threat and threat activities) 212, the threat and/or exploit being simulated 208, and the database of other systems or computer environments with comparable data points, e.g., results of the attacker simulation test of other computer environments 206, the results of the attacker simulation test before implementing recommended security control 214 (e.g., assessment finding such as whether the potential threat was blocked, logged, detected and/or whether a system was comprised can be included), the results of the attacker simulation test after implementing recommended security control 216 (e.g., assessment finding such as whether the potential threat was blocked, logged, detected and/or whether a system was comprised can be included). Information such as whether the recommended settings worked or not worked to prevent cybersecurity attack, can be provided as input. Such information can be included at 206 also. EPGE processes this input, e.g., EPGE compares other systems with similar exploits and technical situations to the target system's results 206. Based on this comparison, technical recommendations that are backed by the data observed in other systems or computer environments can be provided.

In an aspect, exploitability data, which is generated using adversary simulation tools, and configuration settings of various organizations, can be gathered with the permission of those organizations.

In an aspect, organizations can perform on their respective system attacker simulation exercises using exercises that involve an imitation of digital intrusion, attacker simulation tools, and/or combinations of both. An attacker simulation exercise can be performed on a target organization, i.e., an organization for which the exploitability prevention guide is being provided. Such attacker simulation exercise, for example, can test discrete exploit tactics, techniques, and/or procedures in the target organization's computer environment. The results of attacker simulation exercises can be compiled into reports that can include, but not limited to: which exploit tactics, techniques, and/or procedures were tested; how the target organization's environment performed against the tactics, techniques, and/or procedures that were tested, such as whether an exploit was detected, blocked, logged, or responded to by the target organization's security team and tools; and that target organization's computer system information, such as the size of the network, the nature of the network's components, the security tools in place, and the configuration of assets and tooling. In an embodiment, the data from simulation exercise reports can be collected in a database referred to herein as a “context database”.

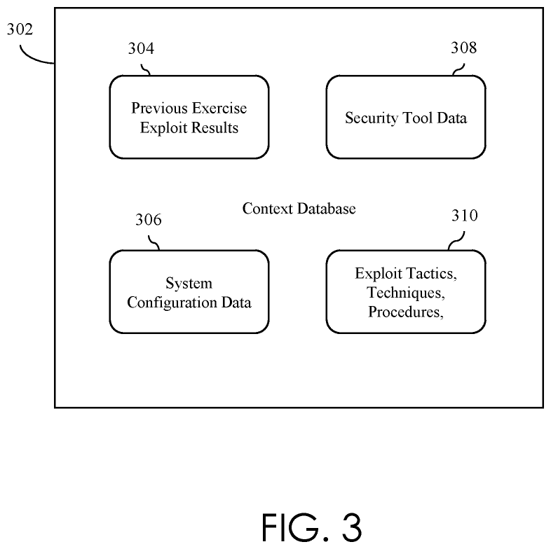

FIG. 3 is a diagram illustrating components of a context database in an embodiment. Context database 302 can be a database stored on a computer storage device. The database 302 can include, but is not limited to, system configuration data 306 of a computer environment, data about security tool or tools 308 employed in that computer environment, exploit tactics, techniques and/or procedures 310 simulated in that computer environment and corresponding exercise exploit results 304. The data (e.g., 304, 306, 308, 310) can be stored for each computer environment that is participating in exploitability prevention guidance. For instance, those data can be indexed by a computer environment identifier.

EPGE can use the context database in combination with data on the tactics, techniques, and/or procedures being used or simulated on the current target organization, the current target organization's attack simulation results, and the current target organization's computer system information, to derive analogous technical situations in use by other organizations that performed better against exploit tactics, techniques, and/or procedures than the current target organization. Examples of analogous technical situations can include, but are not limited to, the presence of similar software applications, security tools (such as Endpoint Detection and Response (EDR), firewalls, Intrusion detection systems (IDS) and intrusion prevention systems (IPS), etc.), similar infrastructure (e.g., server, switch, database, cloud resource types, etc.), and/or device configurations (such as patch level, operating system (OS) settings, enabled and turned-off services, etc.).

The analogous situations are compared within EPGE to determine differentiators that explain the improved performance against the tactics, techniques, and/or procedures in question. The improvement differentiator from analogous organizations can be provided as recommendations to the current target organization for improvement. Differentiators can be specific settings or configurations within analogous components such as operating systems, firewalls, security controls.

Current target organization results can be added to the EPGE context database (e.g., including any applicable re-tests after recommended changes are made) to further enrich or enhance EPGE's dataset.

In an aspect, EPGE can be offered as an accompanying service to automated attacker simulation solutions like automated tools and/or adversary simulations, where recommendations can be improved based on EPGE data.

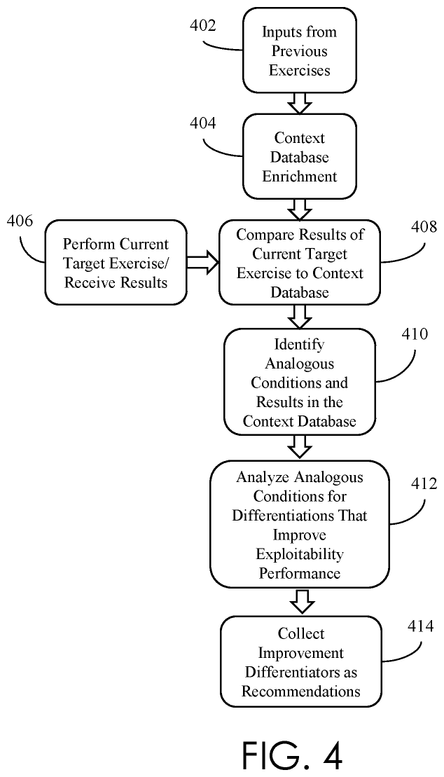

FIG. 4 is a flow diagram illustrating a method of exploitability prevention guidance in an embodiment. For instance, exploitability prevention guidance or recommendation can be provided to a computer environment or system (referred to also as a target computer environment).

In an embodiment, simulated cybersecurity attacks can be performed against various computational environments. Results of the simulated cybersecurity attacks can be logged in a database, e.g., referred to as a context database, where the results can include information related to types of exploits, responses from the various computer environments against respective exploits, and characteristics and configurations of the various computer environments. For example, in an embodiment, various computer environments can be requested to perform simulated cybersecurity attacks and to log results of those attacks. A context database can be built using those results. For instance, results from each computer environment can be received and stored in a context database. In another aspect, the computer environments can be given access to directly log the information in the context database.

For example, at 402, information associated with one or more results of simulated cybersecurity attacks or exercises, e.g., previously performed on computer environments or systems can be received. Such information can be stored in a database, also referred to as a context database. As shown in FIG. 3, the information can include previous exercise exploit results, system configuration data, security tool data and exploit tactics, techniques, procedures. At 404, the information can be used to enrich or update the context database. For example, more recently received information can be used to update or enrich the context database.

At 406, one or more simulated cybersecurity attacks can be performed against a target computer environment. Results of such one or more simulated cybersecurity attacks can be received. An analogous computer environment in the context database having similar characteristics as the target computer environment but performed better against such one or more simulated cybersecurity attacks can be identified, where the analogous computer environment exhibits acceptable cybersecurity hardening from types of exploits used in the performed one or more simulated cybersecurity attacks against the target computer environment.

For example, at 408, the results of the simulated cybersecurity attacks performed against the target computer environment can be compared to the information stored in the context database. The comparison can include two streams: looking for similar environments (e.g., previous targets that are similar in terms of infrastructure, configuration, size, geolocation, etc.); comparing outcomes of the test on the target computer environment across multiple other computer environments (e.g., for a given exploitation TTP, did this target computer environment detect, log, block, respond, prevent the TTP from exploiting the system?). For the second comparison, EPGE prioritizes comparing against environments that are similar on the first stream (similar environments) but looks for different outcomes on the second stream (whether the TTP was successful or not) to determine differentiators about the two target environments to explain the difference in outcomes against the TTP. For instance, EPGE looks for computer environments that both resemble the current target computer environment as closely as possible while also having different outcomes against a TTP the current target computer environment failed against. By way of example, consider that results from a previous exercise shows that Company A, had OS systems version X with hardening settings such as locked down read-only access to the root directory. Company B has the same OS systems version X but no hardening settings. The systems in Company B were not effective in stopping the simulated attack. EPGE can provide the hardening settings difference that should be implemented on company B's OS computer systems with version X. As described above, the context database can store, for each of the plurality of computer environments, previous exploit exercise result, system configuration data, security tool data, and exploit tactic, technique and procedure.

At 410, analogous conditions and results in the context database can be identified. Analogous conditions can include similar information technology (IT) infrastructure (e.g., a threshold number of same servers, switches, operating systems, cloud resources, etc.), similar security tooling (e.g., a threshold number of same EDR, firewalls, IDS/IPS, cloud security tools, etc.), a threshold number of same applications, within a predefined size or industry, and/or others. Analogous results can indicate performance against the same TTPs in previous adversary simulation tests, such as target computer environment's performance in response to the same Active Directory exploit technique as another computer environment against that same exploit technique. EPGE can look for computer environments that have analogous conditions but have different outcomes in analogous results, e.g., so similar IT environments that performed differently (better) against the same exploitation TTPs to generate recommendations for adjustments to the target computer environment to imitate the computer environment having the analogous conditions in a way to achieve their better results.

At 412, analogous conditions can be analyzed for differentiations that improve exploitability performance. For example, EPGE can look for closely similar conditions (e.g., determined by a threshold number of same conditions) while also looking for better outcomes and can enumerate the differences in conditions between the two environments. This can be iterated for as many computer environments as the database contains (e.g., as many similar environments that performed better against a particular TTP that were seen in previous exercises) to refine the differences down to meaningful differences in the question of why other environments performed better. These meaningful differences (differentiators) can be translated into recommendations.

For example, Company A failed to block a particular Active Directory exploit TTP. Companies B through Z, each were able to block the Active Directory exploit TTP that Company A did not block, but of those only Company B through G are similar to Company A (e.g., similar IT environments, e.g., has a threshold number of same IT components). Through an analysis of the characteristics of the environments of Company B through G, EPGE may determine that each of Company B through G is running a more up-to-date patch version of a particular OS for their Active Directory domain controllers than Company A is running for their domain controller (OS versions for systems is one of the data points in the context database). Because this is the only relevant difference between those similar environments that performed better against the TTP that Company A failed to block, EPGE recommends that Company A update the version of that particular OS for their domain controller to the version in use by Company B through G.

At 414, differentiators can be identified and collected as improvement differentiators, which can be provided as recommendations. Differentiators can be specific configuration setting at a level of granularity that may be different even in computer systems that are considered similar or analogous. Examples of such settings can include operating system configuration settings. For example, even though two computer environments can be running on the same operating system (hence analogous), the operating systems can have different settings. Another example can be specific firewall settings in a computer environment. For instance, more granular or detailed configuration settings can be recommended in a computer environment.

For example, the computer-implemented method can also include recommending characteristics and configurations associated with the analogous computer environment to the target computer environment.

In another aspect, the method can further include causing performing of the cybersecurity attack simulations on the plurality of computer environments. The context database can be built based on results of cybersecurity attack simulations performed on the plurality of computer environments, and information associated with those computer environments. The method can also include enhancing the context database with information associated with results of the simulated cybersecurity attack performed against the target computer environment.

In another aspect, the method can further include, after the recommended configurations have been implemented on the target computer environment, receiving information associated with results of another simulated cybersecurity attack performed against the target computer environment and updating the context database with the information. For example, the target computer environment can be caused to implement the recommended configurations and further caused to simulate a cybersecurity attack. In an embodiment, the recommended configurations can include security control configurations the analogous computer environment has implemented.

In an aspect, EPGE can recommend a larger amount of data (e.g., larger scope) and can reference multiple different vectors. In an aspect, EPGE can use results of adverse cybersecurity attack simulations to identify configuration settings and protection controls that can stop, prevent, or detect vulnerabilities in a computer system or environment. For instance, EPGE may strive to find the best configuration settings or controls for a system to be less vulnerable. EPGE in an aspect works to identify specific settings and controls to protect and detect computer systems or environments from vulnerabilities based on simulated attacks.

In an aspect, EPGE can use details on a target computer system's tooling and environment configurations to recommend more secure options based on the success of other environments against a myriad of attack techniques. In an aspect, EPGE's recommendation of effective configurations to counteract an exploit technique is based on the effectiveness of those configurations in other computer system environments. In an aspect, EPGE can consider many different attack techniques and defensive approaches, and can complement broad adversary simulation engagements across many types of infrastructure, configurations, tools, and exploitation techniques.

In an aspect, EPGE may collect actual configuration settings for computer systems and controls to identify the best solutions or settings possible to an attack. EPGE can use attack simulation exercises in conjunction with security controls and systems control settings to create a database of tested configurations, for example, which can be considered best. EPGE can provide useful guidance for securing computer environments on a broad and tailored scope. EPGE can use target computer system's data and continue to evolve recommendations as new data is ingested, leading to improvements to recommendations in line with changing threat behavior or new exploitation techniques.

In an aspect, EPGE can be incorporated as a tool to assist an organizations with actions to help remediate their specific computer or digital environment, risk, or vulnerability. For instance, EPGE can collect data from adversary simulations and target computer system infrastructure to generate recommendations for improvement. EPGE can also be a continuous process and can change over time. In an aspect, EPGE can recommend specific needs to the target computer system's risk, technical environment, and vulnerabilities, help in remediation actions and can provide continuous support as new vulnerabilities, risks, technical environments, and adversary simulations engagements collect data that may be appropriate for remediations in the target computer environment. EPGE can collect real-time live data and recorded data to help with remediations, and can work for different kinds of threat vulnerabilities or compromise methods.

In an aspect. EPGE can provide prescriptive configurations to computer systems. EPGE can provide recommendations involving immediate configuration settings, choice of best tested vendor solution, and application of best test configuration to security controls.

In an aspect, EPGE can function as part of a context of an adversary simulation or such engagement. For instance, after an adversary simulation discovers that certain techniques, procedures can be effective in a computer system or computer environment, EPGE can be used to generate recommendations for mitigation of vulnerabilities based on data from the computer system or computer environment, other computer system or computer environment, and adversary simulation results. In an aspect. EPGE can determine actionable changes that should be made to computer system or environments in response to adversary simulation activity results.

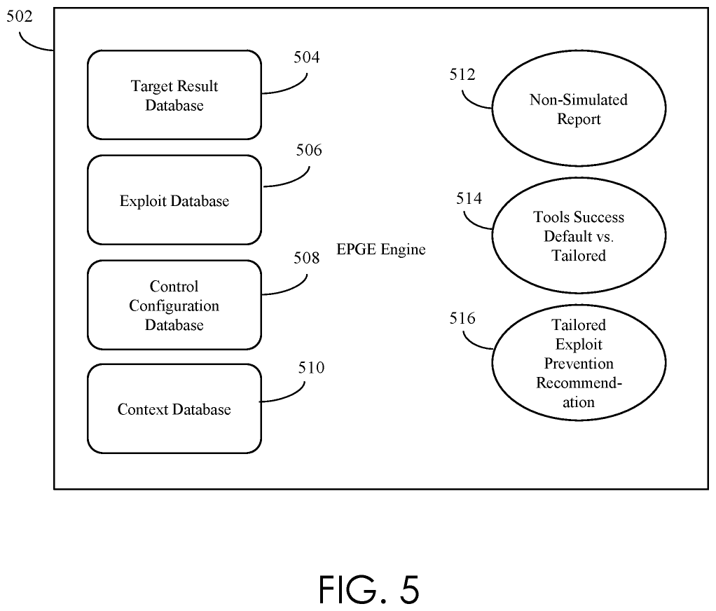

FIG. 5 is a diagram illustrating components of an exploitability prevention guidance engine 502 in an embodiment. Target result database 502 includes or stores data associated with a result or results of one or more cybersecurity attack simulations or exercises performed on a target computer environment (also referred to as target system or target computer system). Exploit database 504 includes data associated with exploitation techniques used in the adversary simulation or used by adversary simulation tools, e.g., tactics, techniques and procedures used in the cybersecurity attack simulations, for example, sequential query language (SQL) overflow attacks and/or others. Control configuration database 506 includes control settings or configuration settings of target computer environment, e.g., security settings, how the settings are configured, what security tools are in place. Context database 508 is used to determine how similar the target computer environment is to other computer environments, e.g., environmental markers such as operating system, size of network topography, software being run on the environments. The data in the databases 504, 506, 508, 510 can be analyzed (e.g., by a processor running the exploitability prevention guidance engine) to compare similarities and differences, based on which recommended actions can be provided. Information such as the type of organization (e.g., industry), size of industry can also be used in the comparison. Based on the analysis, non-simulated reports 512 can be produced such as reports about successful security tools 514 (e.g., both default and tailored, e.g., how an endpoint security product's security control settings were tailored that led to success, whether such a product was applied across the entire environment, what security permission settings were in place, etc.) and tailored exploit prevention recommendations 516, which, e.g., can suggest configuration settings. Such reports can inform which tailoring of security tools can be effective for a particular environment.

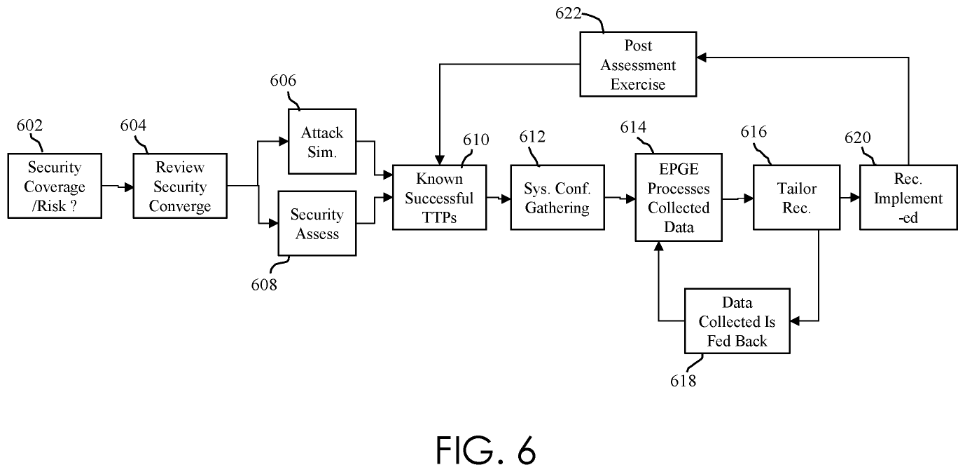

FIG. 6 is a flow diagram illustrating a use case of an exploitability prevention guidance in an embodiment. At 602, an organization may question its security coverage and risk. At 604, the organization may contact a vendor providing cybersecurity services to review its security coverage. The following processing may be performed by the vendor, for example, in cooperation with the organization. At 606, simulations can be performed that imitate cybersecurity attacks on the computer environment of the organization (e.g., also referred to as target computer environment). At 608, a security assessment about the organization's computer environment can be performed. At 610, tactics, techniques and procedures (TTPs) that successfully attacked the target computer environment in the simulation can be determined. At 612, data about the system configuration of the target computer environment is gathered. At 614, the exploitability prevention guidance engine processes the collected data, e.g., as described above. At 616, based on the processing of the collected data, tailored recommendations and insights can be provided. Tailored recommendations can include specific configuration settings at a high level of granularity (e.g., detailed specific settings, for example, down to specific values). Insights can include information as to how the target computer environment would perform again different types of cybersecurity attacks, given its current settings. Such insights can be generated based on comparing the current settings to other computer environments that had similar settings and had previously exercised such TTPs. At 618, such data that is generated can be fed back to the exploitability prevention guidance engine. At 620, the organization may implement the recommendations. At 622, further assessment of the target computer environment can be performed after the recommendation is implemented, for example, by simulating another cybersecurity attack. At 624, based on the simulated another cybersecurity attack, TTPs that penetrated the target computer environment can be identified at 610, and the processing can repeat.

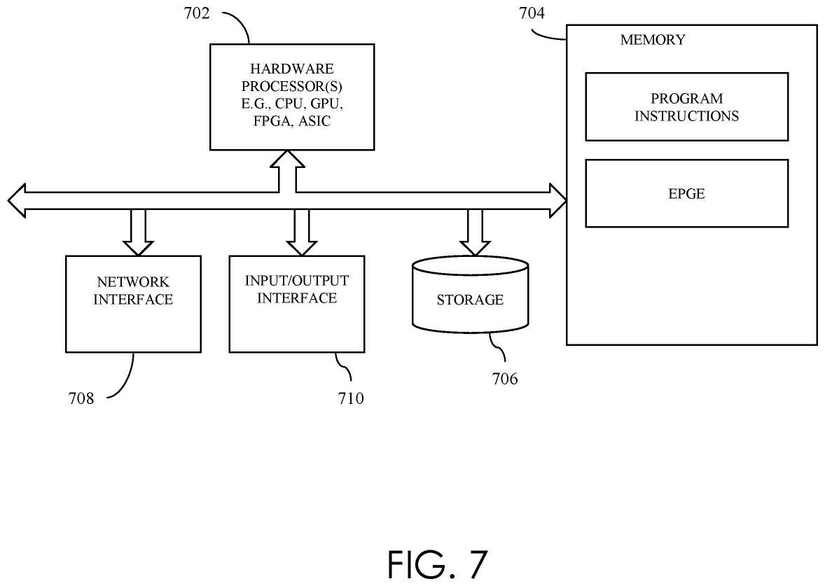

FIG. 7 is a diagram showing components of a processing system in one embodiment that can perform exploitability prevention guidance. One or more hardware processors 702 such as a central processing unit (CPU), a graphic process unit (GPU), and/or a Field Programmable Gate Array (FPGA), an application specific integrated circuit (ASIC), and/or another processor, may be coupled with a memory device 704, and perform exploitability prevention guidance, e.g., to provide actional recommendations for preventing exploits against a computer environment. A memory device 704 may include random access memory (RAM), read-only memory (ROM) or another memory device, and may store data and/or processor instructions for implementing various functionalities associated with the methods and/or systems described herein. One or more processors 702 may execute computer instructions stored in memory 704 or received from another computer device or medium. A memory device 704 may, for example, store instructions and/or data for functioning of one or more hardware processors 702, and may include an operating system and other program of instructions and/or data. One or more hardware processors 702 may perform a simulated cybersecurity attack against a target computer environment, identify an analogous computer environment in a context database, where the context database stores information associated with previously performed cybersecurity attack simulations on a plurality of computer environments, and recommend configurations associated with the analogous computer environment to the target computer environment. Data of the context database, for example, may be stored in a storage device 706 or received via a network interface 708 from a remote device, and may be temporarily loaded into a memory device 704 for performing exploitability prevention guidance. One or more hardware processors 702 may be coupled with interface devices such as a network interface 708 for communicating with remote systems, for example, via a network, and an input/output interface 710 for communicating with input and/or output devices such as a keyboard, mouse, display, and/or others.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving results of a simulated cybersecurity attack performed against a target computer environment;
identifying an analogous computer environment in a context database that performed better against the simulated cybersecurity attack, the context database storing information associated with a plurality of computer environments and previously performed cybersecurity attack simulations on the plurality of computer environments; and
recommending configurations associated with the analogous computer environment to the target computer environment.

2. The computer-implement method of claim 1, wherein the context database stores, for each of the plurality of computer environments, previous exploit exercise result, system configuration data, security tool data, and exploit tactic, technique and procedure.

3. The computer-implement method of claim 1, further including, after the recommended configurations have been implemented on the target computer environment, receiving information associated with results of another simulated cybersecurity attack performed against the target computer environment and updating the context database with the information.

4. The computer-implement method of claim 1, wherein the context database is built based on results of the cybersecurity attack simulations on the plurality of computer environments.

5. The computer-implement method of claim 1, further including enhancing the context database with information associated with results of the simulated cybersecurity attack performed against the target computer environment.

6. The computer-implement method of claim 1, wherein the analogous computer environment is identified that exhibits acceptable cybersecurity hardening from types of exploits employed in the simulated cybersecurity attack.

7. A computer program product comprising a computer readable storage medium having program instructions embodied therewith, the program instructions readable by a device to cause the device to:
receive results of a simulated cybersecurity attack performed against a target computer environment;
identify an analogous computer environment in a context database that performed better against the simulated cybersecurity attack, the context database storing information associated with a plurality of computer environments and previously performed cybersecurity attack simulations on the plurality of computer environments; and
recommend configurations associated with the analogous computer environment to the target computer environment.

8. The computer program product of claim 7, wherein the context database stores, for each of the plurality of computer environments, previous exploit exercise result, system configuration data, security tool data, and exploit tactic, technique and procedure.

9. The computer program product of claim 7, wherein the device is further caused to, after the recommended configurations have been implemented on the target computer environment, receive information associated with results of another simulated cybersecurity attack performed against the target computer environment and update the context database with the information.

10. The computer program product of claim 9, wherein the context database is built based on results of the cybersecurity attack simulations on the plurality of computer environments.

11. The computer program product of claim 7, wherein the device is further caused to enhance the context database with information associated with results of the simulated cybersecurity attack performed against the target computer environment.

12. The computer program product of claim 7, wherein the analogous computer environment is identified that exhibits acceptable cybersecurity hardening from types of exploits employed in the simulated cybersecurity attack.

13. A system comprising:
at least one processor;
at least one memory device coupled with the at least one processor;
the at least one processor configures to at least:
receive results of a simulated cybersecurity attack performed against a target computer environment;
identify an analogous computer environment in a context database that performed better against the simulated cybersecurity attack, the context database storing information associated with a plurality of computer environments and previously performed cybersecurity attack simulations on the plurality of computer environments; and
recommend configurations associated with the analogous computer environment to the target computer environment.

14. The system of claim 13, wherein the context database stores, for each of the plurality of computer environments, previous exploit exercise result, system configuration data, security tool data, and exploit tactic, technique and procedure.

15. The system of claim 13, wherein said at least one processor is further configured to, after the recommended configurations have been implemented on the target computer environment, receive information associated with results of another simulated cybersecurity attack performed against the target computer environment and update the context database with the information.

16. The system of claim 15, wherein the context database is built based on results of the cybersecurity attack simulations on the plurality of computer environments.

17. The system of claim 13, wherein said at least one processor is further configured to enhance the context database with information associated with results of the simulated cybersecurity attack performed against the target computer environment.

18. The system of claim 13, wherein the analogous computer environment is identified that exhibits acceptable cybersecurity hardening from types of exploits employed in the simulated cybersecurity attack.

19. The system of claim 13, wherein the recommended configurations include security control configurations the analogous computer environment has implemented.
